(19) United States
(12) Patent Application Publication
(10) Pub. No.: US 2019/0281280 A1
(43) Pub. Date: Sep. 12, 2019

(54) Parallax Display using Head-Tracking and Light-Field Display

(71) Applicant: Antimatter Research, Inc., Palo Alto, CA (US)

(72) Inventors: James Armand Baldwin, Palo Alto, CA (US); Andrew Wayne Walters, Castroville, CA (US); Peter Macdonald, Redwood City, CA (US); Gladys Yyen Yan Wong, Fremont, CA (US); Hedley Davis, Middletown, DE (US); Kevin Meier, Belmont, CA (US)

(21) Appl. No.: 16/229,806

(22) Filed: Dec. 21, 2018

Related U.S. Application Data
(60) Provisional application No. 62/609,643, filed on Dec. 22, 2017.

(51) Int. Cl. H04N 13/383; H04N 13/302; G06K 9/00; H04N 5/247

(52) U.S. Cl. CPC H04N 13/383; H04N 13/302; H04N 5/247; G06K 9/00281; G06K 9/00255

(57) ABSTRACT

A parallax-based 3D display that comprises a light-field component, making it possible for multiple viewers to view the 3D display.

### CROSS-REFERENCE TO RELATED APPLICATIONS

The present application takes priority from Provisional Application No. 62/609,643, filed Dec. 22, 2017, which is incorporated herein by reference.

### BACKGROUND

Glasses-free 3D displays are an active field of development. The general approach to creating such a display is to structure the surface so different pixels are seen from different angles, typically using either a micro-lens structure on the surface of the display, or a backlight that casts light rays directionally through a display.

These techniques have size and scale limitations. Each view of each pixel of the display is exposed to a pyramid-shaped region emanating from the surface. To achieve a 3D effect, the viewer's eyes must see different views. This frequently causes headaches and nausea for viewers. In addition, as the viewing distance increases, the size of the viewing region does as well, and the viewer can no longer typically see two different views from each eye. To deal with this, as the viewing distance increases, the display must have larger and larger numbers of views with higher density, which becomes impractical for display manufacturing reasons as well as the need to render ever more views of a scene.

At the same time, a different technique for simulating 3D displays exists using the ability to track a user's head position. By calculating the point of view of a user, and rendering a single view of the scene based on that position, the viewer experiences parallax as she moves her head around, creating a 3-dimensional feel to the scene. This does not require rendering separate views for each eye, and is therefore significantly cheaper. The problem with this approach is only one viewer can experience parallax at a time since only one view of the scene can be rendered.

A need exists for a head-tracking light-field display that works for multiple users.

### LIST OF FIGURES

FIG. 1 shows a diagram of a prior-art light-field display.

FIG. 2 shows a diagram of a prior-art parallax display.

FIG. 3 shows an exemplary system of the present invention.

FIG. 4 shows a block diagram of the display of an embodiment of the present invention.

FIG. 5 shows a block diagram of the computing device of an embodiment of the present invention.

FIG. 6 shows a flowchart of the operation of the computing device in an embodiment of the present invention.

### SUMMARY OF THE INVENTION

An object of the present invention is to provide a glasses-free parallax display of a three-dimensional scene that works for multiple viewers.

Another object of the present invention is to provide a cheaper and simpler system for displaying a virtual three-dimensional scene for multiple viewers.

An aspect of the present invention comprises an image display apparatus comprising a light field display device with at least two light field display segments, each segment defining a viewer cone displaying a view of the visual content for a viewer located inside the cone. A computing device is connected to the display and is configured to detect a presence of a first viewer in front of the display device and determine the location of the first viewer's head and the light field display segment in which the first viewer's head is located. Then, the computing device displays a two-dimensional view of a virtual (or real) three-dimensional screen on the display device from the point of view of the first viewer's head in the light field segment in which the first viewer's head is located.

In an aspect of the invention, if the computing device detects a second viewer's head in front of the display device, it is also configured to detect the location of the second viewer's head and determine the light field segment in which the second viewer's head is positioned. The device then displays a second two-dimensional view of the virtual (or real) three-dimensional scene in the light field segment in which the second viewer's head is located.

The three-dimensional scene may be a fisheye lens view of a real scene, a wide-angle view of a real scene, or a virtual three-dimensional scene. The three-dimensional scene may also be generated by multiple cameras or another mechanism known in the art for generating a three-dimensional scene from a real or virtual scene.

The light field display may have any number of segments, both horizontally and vertically, and each viewer cone may subtend a viewing angle of any amount. In an embodiment, the number of segments is determined by the formula

$$n = \frac{π d}{v} ,$$

where n is the number of segments, d is an approximate desired distance between a viewer and the display, and v is an approximate desired distance between viewers.

In an embodiment, if a viewer's head is at a boundary between two segments, both segments display the same parallax image of the visual content.

In an embodiment, the computing device is further configured to estimate a distance between the viewer and the display device and display an image of the three-dimensional scene that is based on the distance between the viewer and the display. The estimate may be based on the distance between the viewer's eyes, a depth sensor, stereo disparity, or facial recognition techniques.

In an embodiment, the computing device estimates a distance between the viewer and the display device by utilizing stereo disparity between at least two cameras. To do so, a first image is captured using a first camera, and a second image using a second camera, wherein the second camera is displaced from the first camera (horizontally, vertically, or in any other way). Then, the computing device uses a face detection algorithm to identify at least one facial key point in each image, such as an eye, nose, mouth, chin, ear, cheek, forehead, eyebrow. A rectification transform is performed on each facial key point so that the corresponding key points in the two images vary only by a disparity. Then, the disparity between each facial key point is used to calculate the distance between the facial key point and the display device. In an aspect of the invention, the second camera is displaced horizontally from the first camera. In an aspect of the invention, the computing device identifies any errors in the distance estimation by comparing the distance of different key points.

### DETAILED DESCRIPTION OF THE PREFERRED EMBODIMENT

It will be understood that the below description is solely a description of one embodiment of the present invention and is not meant to be limiting. Any equivalents to any elements of the present invention that will be apparent to a person of reasonable skill in the art will be understood to be included in the present description.

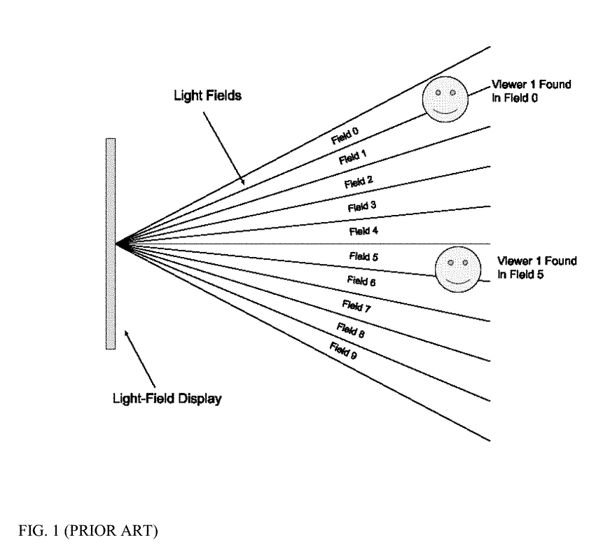

FIG. 1 shows a prior art light-field display. As can be seen from the Figure, a light-field display shows a different view at each viewing angle; i.e. Viewer 1 can see a different view of the same scene from different viewing angles, adding to the realism of the display. However, as mentioned above, at large viewing distances, many different views of the same scene are required, making a light-field display very costly.

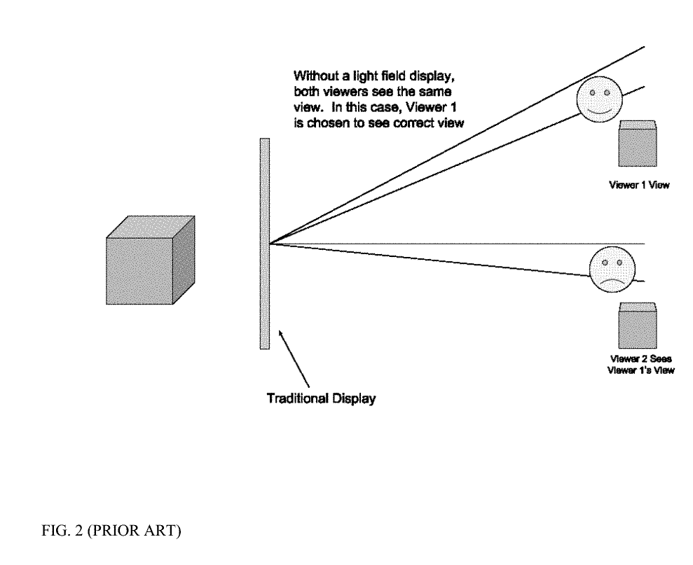

FIG. 2 shows a prior art parallax display. This type of display tracks a viewer's head movement and changes the displayed scene based on the viewer's head position. Since this display is dependent on head tracking, it only works for one viewer. Viewer 2 will see a distorted scene that will change based on the head movements of Viewer 1, which will destroy the illusion of realism for Viewer 2.

The present invention makes it possible for a parallax display to be used with multiple viewers, displaying a realistic scene based on the viewer's head position for each viewer.

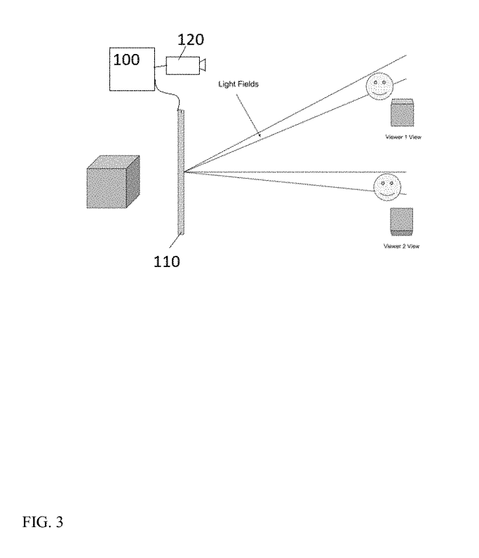

FIG. 3 illustrates an exemplary system configured to implement various embodiments of the techniques described below.

As shown in FIG. 3, an exemplary system of the present invention comprises a computing device 100 connected to a display 110. The display 110 is a light-field display device with at least two segments, each segment being only visible from a pyramid-shaped area and being invisible from outside that pyramid-shaped area of space. The system also comprises a camera 120 that is configured to capture images in front of the display 110. The computing device is configured to determine whether a viewer is present in front of the display 110, to identify the viewer's head, and to determine in what segment of the light-field display the viewer's head is located. If a viewer's head is located in front of the display, the computing device is configured to display a view of a three-dimensional scene from the point of view of the viewer's head, in the segment in which the viewer's head is located. The computing device then tracks the viewer's head and changes the view based on the viewer's head position.

If a second viewer is present in front of the display, as shown in FIG. 3, the computing device identifies the second viewer's head and determines in what segment of the light field display the second viewer's head is located. The computing device then displays a view of the three-dimensional scene from the point of view of the second viewer's head in the segment in which the second viewer's head is located. The computing device then tracks the second viewer's head and changes the view based on the second viewer's head position.

As is clear from the description, the system of the present invention does not provide different views to a viewer's right and left eye, opting instead for motion parallax. This allows the system to operate with much fewer segments in the light field display and to operate even when a viewer is at a large distance from the display. Systems that provide different views to each eye by means of a light field display have to have enough segments in the light field that each eye is located in a separate segment. For the system of the present invention, each segment can be wide enough so that a viewer can move around within it. This means that fewer segments can be used, saving costs and complexity.

One other advantage of the system of the present invention over the systems that provide left and right eye views is that such systems often cause dizziness and nausea in the viewer. The effect of the system of the present invention is a flat display that changes based on a viewer's head position, similarly to the way a view through a window would change based on a viewer's head position. This is a lot more comfortable and natural for a viewer and does not result in dizziness or nausea.

The display 110 may be of any size and any distance from the viewer. In an aspect of the invention, the display is a Diffractive Light-Field Backlit display. It will be understood that the present invention is preferably used for large wall-mounted displays that are intended to be viewed by multiple people, but the present invention is not limited to any particular size or application of the display and may be used for any display where a 3D feel is desired.

In an embodiment, the segments are sized so that two people standing side by side would be in different segments when located at a comfortable preferred viewing distance from the display. For example, a display that is preferably viewed from 10 feet away could have segments that provide 1 feet of width per segment at that distance. This ensures that people who are standing or sitting next to each other are still placed in different segments and can move around within those segments to provide for a motion parallax effect.

In an embodiment, the segments are sized according to the formula

$$n = \frac{π d}{v} ,$$

where n is the number of segments, d is an approximate desired distance between a viewer and the display, and v is an approximate desired distance between viewers. Thus, if two viewers are standing 15 feet from the display with their heads 3 feet apart, the system will need 16 segments to ensure the viewers are seeing different images. This assumes that the segments project at fixed, equal widths (which is not required for practicing the present invention).

The camera 120 is preferably a camera that has enough resolution to capture a human face at a reasonable viewing distance from the display. In an aspect of the invention, the camera is a has a resolution of 3840×2160 pixels. In an aspect of the invention, multiple cameras may be used. The camera may be an infrared camera or may capture visible light. An infrared illuminator may be used in conjunction with an infrared camera to ensure the system functions in the dark. The camera may also operate at a significantly higher frame rate than is required for video capture, to reduce the latency of capture and thus the feeling of lag in the response of the system.

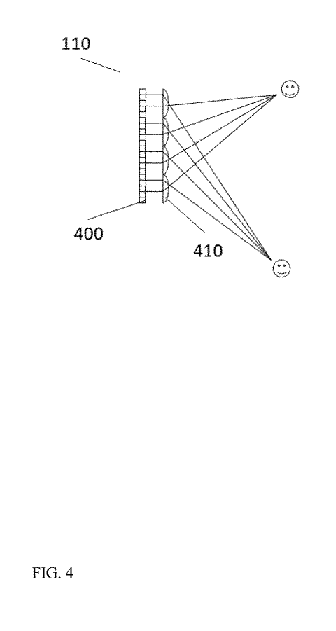

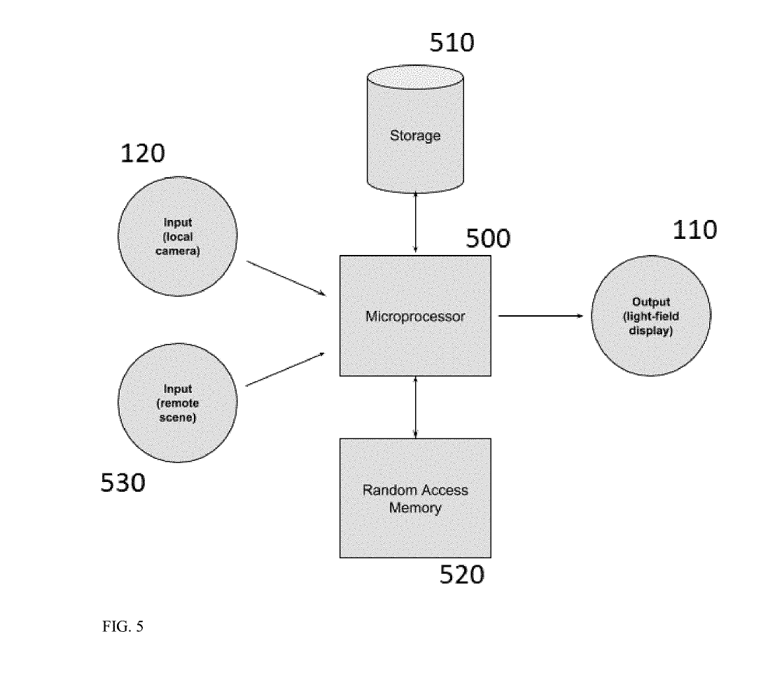

FIG. 4 shows a block diagram of the display 110. A pixel layer 400 is overlaid with a lens array layer 410. Each lens in the lens array 410 directs light from a particular pixel in the pixel layer 400 to a particular viewing segment, as shown. Since each lens overlays a group of several pixels, each pixel under the lens is displayed in a different viewing segment. This results in different images displayed in different viewing segments.

FIG. 5 shows a block diagram of the computing device 100. The computing device is connected to the camera 120 and the display device 110 by wired or wireless connection. In an embodiment, the computing device is also connected to an input device 530 for capturing a remote scene (a camera pointed at a real-world scene, for example). The computing device 100 comprises a processor 500, at least one storage medium 510, a random-access memory 520, and other circuitry for performing computing tasks. The storage medium may store computer programs or software components according to various embodiments of the present invention. In an embodiment, the memory medium may also store data, such as images, virtual or real 3D scenes, and so on. The computing device 100 may be connected to the Internet via a communication module (not shown).

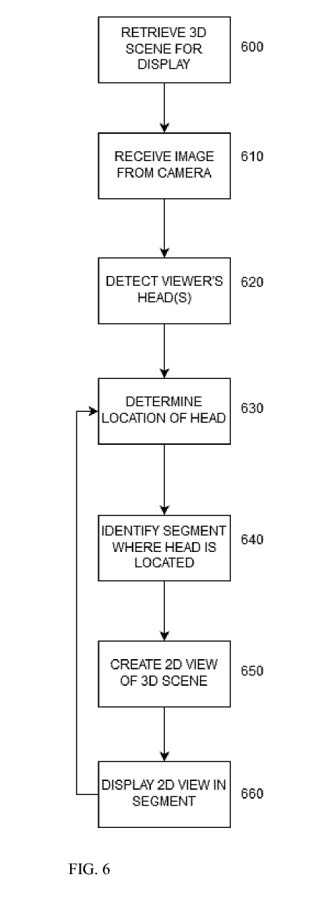

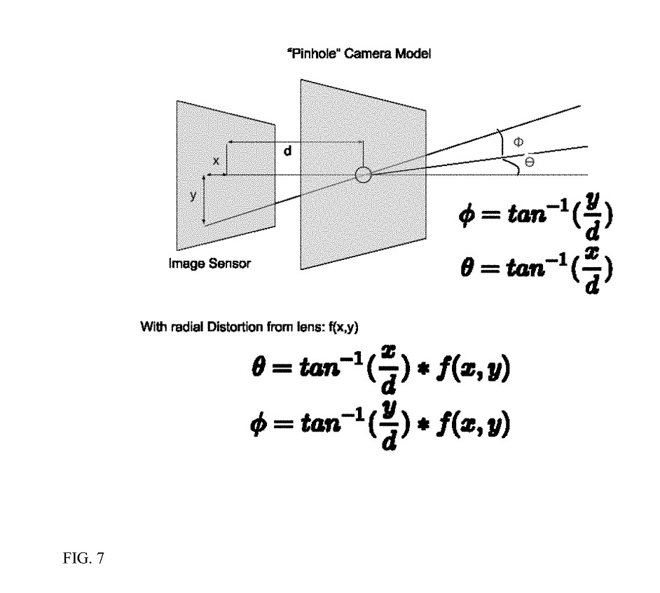

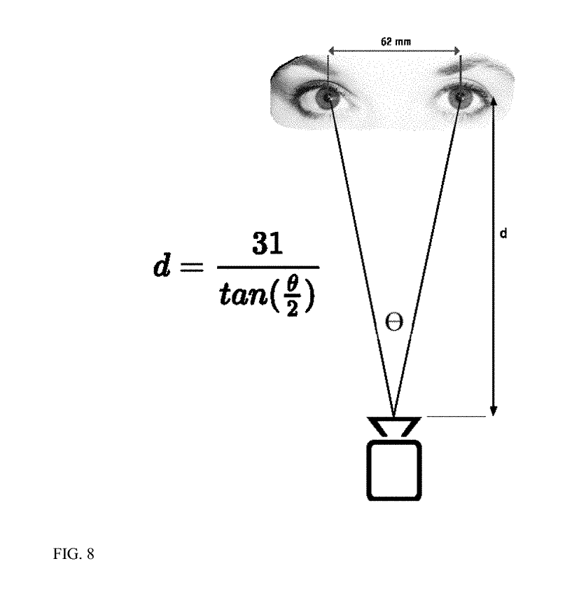

FIG. 6 shows a flowchart of the operation of the computing device 100. The computing device first retrieves a three-dimensional scene from memory for display 600. The computing device also receives 610 images from the camera and detects 620 any human heads present in the image. If a viewer's head is present in the image, the computing device next determines 630 the segment in which the viewer's head is located and determines 640 the exact location of the viewer's head with respect to the display. Once that is determined, the computing device determines 650 a two-dimensional view of the three-dimensional scene from the viewer's head's point of view and displays 660 that two-dimensional view in the segment in which the human head is present. For as long as the viewer's head is present in front of the display, the computing device keeps tracking its position and updating the two-dimensional view as needed. This enables the viewer to see a realistic parallax view of a virtual three-dimensional scene.

If the computing device detects more than one human head in the image, the computing device performs the above actions for each viewer. If the viewers are in different segments of the light field display, each segment displays the view of the three-dimensional scene that is correct for the viewer present in that segment and tracks the position of the viewer's head and updates the view as the viewer moves. While the segments are preferably sized so that only one viewer could be present in each segment, if two viewers are present in the same segment, the midpoint between the two users' positions is interpolated to approximate the correct point of view for both users.

In an embodiment, the determination of the exact location 640 is limited only to the X and Y coordinates in front of the display—i.e. the computing device does not determine the distance between the viewer and the display. In another embodiment, the determination of the exact location 640 includes X, Y, and Z coordinates of the viewer's head in front of the display. This enables the computing device to display a more realistic view of the three-dimensional scene for the viewer, creating a “looking through a window” effect.

In the preferred embodiment, the system may also save energy by turning off the display in a segment where no viewers are present.

If a viewer is present at the borderline between two segments, in an embodiment, the computing device causes both segments to display the same two-dimensional view. As the viewer moves from the borderline into one particular segment, the other segment can turn off

In an embodiment, the computing device uses face detection to determine the number and position of viewers. This is advantageous because it enables the system to know the position of the viewer's eyes. Once the system has determined the position of the viewer's eyes, it may use either a monocular or a binocular estimate for the viewer's position. If monocular, the system uses a single camera and estimates the distance by eye distance. If binocular, the system triangulates from two points of view.

In an embodiment, the computing device uses a depth sensor to estimate the distance between each viewer and the display. In other embodiments, the computing device may use facial recognition techniques to estimate the distance between the viewer and the display eye distance.

The distance between a viewer and the display may be used to modify the displayed image in an embodiment of the present invention—i.e. the displayed image may be dependent on the distance between the viewer and the display. This heightens the illusion of “looking through a window” and makes the experience more realistic. In another embodiment, to save computational power, the displayed image may not be dependent on the viewer's distance from the display.

In an embodiment, the distance between the viewer and the display may be determined via stereo disparity. Two or more cameras are used for that purpose; in an aspect of the invention, two cameras are used. The two cameras are set up to be aligned with each other except for a horizontal shift. A calibration step is performed on the cameras prior to their use; for that calibration step, a known test pattern (such as a checkerboard or any other test pattern) is used to calculate the cameras' intrinsic parameters, such as focal length and lens distortion, and extrinsic parameters, such as the precise relative position of the two cameras with relation to each other. Then, the rectification transform for each camera is calculated. Since the two cameras can't be perfectly aligned, the rectification transform is used to fine tune the alignment so that corresponding points in the images from the two cameras differ only by a horizontal shift (i.e. the disparity). The rectification process may also provide a transform that maps disparity to depth.

After the calibration steps above are performed, the two cameras are used as follows in an embodiment of the invention. An image is captured from each of the two cameras simultaneously (i.e. an image of the viewer's head in front of the display). Each image is then run through its camera's rectification transform. After that, for each pixel in each image, the corresponding point in the other image is found. This is the disparity of each pixel in the image. A disparity map is created based on these calculations. From the disparity map, a depth map is calculated; this is performed by any known stereo disparity calculation method.

After the depth map is calculated, a face detection algorithm is used on the image to determine the position of a viewer's face. The depth (i.e. distance) of the viewer's face is then known.

In another embodiment of the invention, depth (i.e. distance) is determined by matching feature points. After the images are captured from the two cameras, a feature extraction process is run that identifies key points in the image. In the preferred embodiment, the key points are facial features, such as eyes, nose, or mouth. The coordinates of each key point are then run through the rectification transform described above. The depth of each key point is then computed from its disparity. This embodiment is more economical in that it only computes the depth for a few key points rather than the entire image. In an aspect of this embodiment, the depth measurements of multiple key points can be sanity-checked to validate the face detection process. For example, the depth of one eye should not vary much from the other eye.

The system of the present invention may be used to display real or virtual scenes. The effect in either case is an illusion of “looking through a window”—while the viewer sees a flat two-dimensional screen, the parallax effect as the viewer moves their head creates an illusion of three-dimensionality.

In an embodiment, the system of the present invention is used to display a real scene. The images of the real scene are preferably taken with a wide angle (fisheye lens) camera, which enables the system to present the viewer with many more views of the remote scene than would be available through a regular camera, heightening the illusion of “looking through a window”.

In an embodiment, the system of the present invention is used to display a virtual scene, such as a scene in a videogame. The same process is used to generate two-dimensional views of the virtual three-dimensional scene as is used to generate those views for a real three-dimensional scene.

The scope of the present invention is not limited to the embodiments explicitly disclosed. The invention is embodied in each new characteristic and each combination of characteristics. Any reference signs do not limit the scope of the claims. The word “comprising” does not exclude the presence of other elements or steps than those listed in the claim. Use of the word “a” or “an” preceding an element does not exclude the presence of a plurality of such elements.

1. An image display apparatus for displaying visual content of a three-dimensional scene, comprising:
a display device comprising a light field display, wherein the light field display comprises:
at least two light field display segments, each segment defining a viewer cone displaying a view of the visual content for a viewer located inside the viewer cone;
a computing device connected to the display device, wherein the computing device is configured to:
detect a presence of a first viewer in front of the display device and determine a location of the first viewer's head;
determine a first light field display segment in which the first viewer's head is located;
display a two-dimensional view of the three-dimensional scene in the first light field display segment, wherein the two-dimensional view is a view of the three-dimensional scene from the location of the first viewer's head.

2. The image display apparatus of claim 1, wherein the computing device is further configured to:
detect a presence of a second viewer in front of the display device and determine a location of the second viewer's head;
determine a second light field display segment in which the second viewer's head is located;
display a second two-dimensional view of the three-dimensional scene in the second light field display segment, wherein the second two-dimensional view is a view of the three-dimensional scene from the location of the second viewer's head.

3. The image display apparatus of claim 1, wherein the three-dimensional scene is a virtual three-dimensional scene.

4. The image display apparatus of claim 1, wherein the three-dimensional scene is a real scene photographed with a fisheye lens camera.

5. The image display apparatus of claim 1, wherein the number of segments is determined by the formula
$$n = \frac{π d}{v} ,$$
where n is the number of segments, d is an approximate desired distance between a viewer and the display, and v is an approximate desired distance between viewers.

6. The image display apparatus of claim 1, wherein the computing device is further configured to:
detect if a viewer's head is located at a boundary between two segments;
trigger the light field display to display the same parallax image of the visual content in each of the two segments.

7. The image display apparatus of claim 1, wherein the computing device is further configured, for each viewer, to:
estimate a distance between the viewer and the display device;
display an image of the three-dimensional scene that is based on the distance between the viewer and the display.

8. The system of claim 7, wherein the computing device is configured to estimate a distance between the viewer and the display device by analyzing a distance between the viewer's eyes.

9. The system of claim 7, further comprising a depth sensor, wherein the computing device is configured to estimate a distance between the viewer and the display device by analyzing data from the depth sensor.

10. The system of claim 7, wherein the computing device is configured to estimate a distance between the viewer and the display device by using facial recognition techniques.

11. The system of claim 7, wherein the computing device is configured to estimate a distance between the viewer and the display device by performing the following steps:
capturing a first image using a first camera;
capturing a second image using a second camera, wherein the second camera is displaced from the first camera;
use a face detection algorithm to identify at least one facial key point in each image, wherein the at least one facial key point is selected from the following group: eye, nose, mouth, chin, ear, cheek, forehead, eyebrow;
perform a rectification transform on each facial key point in the images so that corresponding key points vary only by a disparity;
use the disparity between each facial key point to calculate the distance between the facial key point and the display device.

12. The system of claim 11, wherein the displacement between the first camera and second camera is horizontal and not vertical.

13. The system of claim 11, wherein the computing device further performs the following step:
identify errors by comparing the distance of at least two distinct key points.

14. A method for displaying visual content, comprising:
retrieving a three-dimensional scene from the memory of a computing device, wherein the computing device is connected to a display device comprising a light field display, said light field display comprising at least two segments;
using a camera to detect a first viewer's head in front of the display device;
determining what segment of the light field display is occupied by the first viewer's head;
displaying a two-dimensional view of the three-dimensional scene in the segment occupied by the first viewer's head, wherein the two-dimensional view is a view of the three-dimensional scene from the location of the first viewer's head.

15. The method of claim 13, comprising detecting a second viewer's head in front of the display device, determining what segment of the light field display is occupied by the second viewer's head, and displaying a second two-dimensional view of the three-dimensional scene in the segment occupied by the second viewer's head, wherein the second two-dimensional view is a view of the three-dimensional scene from the location of the second viewer's head.

16. The method of claim 13, further comprising:
if the viewer's head is located at the boundary between two segments of the light field display, displaying the same view in both segments of the light field display.

17. The method of claim 13, further comprising:
detecting a distance between the viewer's head and the display device;
displaying a view of the three-dimensional scene from the point of view of the viewer's head in the segment of the light field display.

18. The method of claim 16, wherein the distance is detected by facial recognition.

19. The method of claim 16, wherein the distance is detected by analyzing an eye distance of the viewer's face.

20. The method of claim 16, wherein the distance is detected by a depth sensor.

21. The method of claim 16, wherein the distance is detected by the following steps:
capturing a first image using a first camera;
capturing a second image using a second camera, wherein the second camera is displaced from the first camera;
using a face detection algorithm to identify at least one facial key point in each image, wherein the at least one facial key point is selected from the following group: eye, nose, mouth, chin, ear, cheek, forehead, eyebrow;
performing a rectification transform on each facial key point in the images so that corresponding key points vary only by a disparity;
using the disparity between each facial key point to calculate the distance between the facial key point and the display device.

22. The method of claim 20, wherein the displacement between the first and second camera is horizontal but not vertical.

23. The method of claim 16, wherein the three-dimensional scene is a virtual three-dimensional scene.

24. The method of claim 16, wherein the three-dimensional scene is a real scene photographed with a fisheye lens camera.
